(19) United States
(12) Patent Application Publication
(10) Pub. No.: US 2011/0005650 A1
(43) Pub. Date: Jan. 13, 2011

(54) Pneumatic Tire

(75) Inventor: Akinori Miyake, Osaka (JP)

Correspondence Address: FISH & RICHARDSON P.C. (NY), P.O. BOX 1022, MINNEAPOLIS, MN, 55440-1022, US

(73) Assignee: Toyo Tire & Rubber Co., Ltd., Osaka (JP)

(21) Appl. No.: 12/824,320

(22) Filed: Jun. 28, 2010

(30) Foreign Application Priority Data
Jul. 7, 2009 (JP) 2009-160888

(51) Int. Cl. B60C 11/12

(52) U.S. Cl. 152/209.16

(57) ABSTRACT

An object of the present invention is to provide a pneumatic tire capable of preventing the step-wear in shoulder land portion and increases anti-irregular wear performance. In order to achieve the object, a thin groove is included on the tread surface, the thin groove comprises a first cut groove and a second cut groove, both of which have a start point thereof on an inner side wall of the thin groove as viewed in the width direction of the tire, the second cut groove is located at the inner side than the first cut groove as viewed in the diameter direction of the tire, and the bottom of the first cut groove is located at the inner side than an upper position of the opening of the second cut groove as viewed in the diameter direction of the tire.

### BACKGROUND OF THE INVENTION

1. Field of the Invention

The present invention relates to a pneumatic tire comprising a tread surface, the tread surface including: a shoulder land portion extending in a circumferential direction of the tire; and a thin groove located at the inner side than a ground-contact end of the shoulder land portion as viewed in a width direction of the tire and extending in a circumferential direction of the tire, the thin groove partitioning the shoulder land portion into a main land portion located at the inner side and a sacrifice land portion located at the outer side of the shoulder land portion as viewed in the width direction of the tire.

2. Description of the Related Art

In a running pneumatic tire, generally the ground-contact pressure tends to be increased in the vicinity of ground-contact end of shoulder land portion in its tread surface. As a result, this brings about a problem of irregular wear such that, compared to other land portion of the tread surface, volume of wear is larger in the vicinity of ground-contact end of the shoulder land portion. As a method to prevent such irregular wear, for example, a thin groove 30 is generally formed as shown in FIG. 4A, in which the thin groove 30 is located at the inner side than a ground-contact end LE and extends in a circumferential direction of the tire in the vicinity of ground-contact end LE of the shoulder land portion of the tread surface as viewed in the width direction of the tire.

However, even when the thin groove 30 is formed, there is a problem such that, while the tire is used, in a thin groove side end portion 10E in the main land portion 10 (in the main land portion 10, the vicinity of corner line formed by the thin groove 30 and the main land portion 10), the volume of wear becomes larger than the other part and, in the main land portion 10, the thin groove side end portion 10E is worn in a round shape in cross-section (FIG. 4B). As a result, the tire suffers such a problem that the diameter of the tire in the thin groove side end portion 10E may be different from that in the contact surface of other shoulder land portion of the main land portion 10. Therefore, in the case of a pneumatic tire in which only the thin groove 30 is formed, during running, a slip may be caused by the difference in diameter of the tire resulting in a step-wear (irregular wear) as shown in FIG. 4C.

In a sacrifice land portion 20 which is located at the outer side of a tread surface partitioned by the thin groove 30 as viewed in the width direction of the tire, the larger stiffness provides the more effectiveness to reduce irregular wear. On the other hand, when the stiffness is too large in the sacrifice land portion 20, stress is converged on the bottom of the thin groove 30 due to deformation of sacrifice land portion 20 caused during running resulting in cracks in the groove bottom of the thin groove 30. Irrespective of the stage of use of the tire from beginning to intermediate stage, a problem of so-called “chunking”, in which the sacrifice land portion 30 is broken, may occur.

Japanese Unexamined Patent Publication (Kokai) No. 7-76204 describes a pneumatic tire used for heavy load wheel, which has a shoulder land portion formed with a thin groove extending in a circumferential direction of the tire. In this tire, on an inner side wall of the thin groove as viewed in a width direction of the tire, at least one cut groove, which extends in the circumferential direction of the tire, is formed. It is arranged so that area S1 of the inner side wall of the thin groove is larger than area S0 of the outer side wall of the thin groove as viewed in the width direction of the tire; thereby irregular wear of the shoulder land portion can be prevented as well as generation of cracks at the bottom of the thin groove can be prevented. However, in such pneumatic tire used for heavy load wheel, as the tire is used, when the cut groove is exposed to the tread contact surface due to the ordinary wear, a state same as the step-wear shown in FIG. 4C is generated. As a result, when the tire is further used, the step-wear portion is enlarged causing a problem that anti-wear performance of the tire is largely reduced.

Also, Japanese Unexamined Patent Publication (Kokai) No. 11-301214 describes a pneumatic tire which has a shoulder land portion formed with a thin groove extending in a circumferential direction of the tire, in which the depth and width of the thin groove are specified, and on the inner side wall of the thin groove as viewed in a width direction of the tire, at least one circular groove continuously extending in a circumferential direction of the tire is formed; thereby, even when step-wear is generated in the shoulder land portion, cracks at the bottom of the thin groove is prevented. However, in this pneumatic tire, generation of step-wear in the shoulder land portion is not prevented in full process of the wear (from the beginning stage to the final stage of use of the tire); there is a room for further improvement in view of preventive effect against the step-wear.

### SUMMARY OF THE INVENTION

Under these circumstances, the present invention has been made and an object thereof is to provide a pneumatic tire that is capable of preventing the step-wear in shoulder land portion and increases anti-irregular wear performance.

The above object can be achieved by the present invention described below. That is, the pneumatic tire of the present invention comprises a tread surface, the tread surface including: a shoulder land portion extending in a circumferential direction of the tire; and a thin groove located at the inner side than a ground-contact end of the shoulder land portion as viewed in a width direction of the tire and extending in a circumferential direction of the tire, the thin groove partitioning the shoulder land portion into a main land portion located at the inner side and a sacrifice land portion located at the outer side of the shoulder land portion as viewed in the width direction of the tire; the thin groove comprising: a first cut groove that extends in a circumferential direction of the tire, has a start point thereof on an inner side wall of the thin groove as viewed in the width direction of the tire, and is inclined so that the bottom thereof is located at the inner side than the opening thereof as viewed in the diameter direction of the tire; and a second cut groove that extends in the circumferential direction of the tire, has a start point thereof on the inner side wall of the thin groove as viewed in the width direction of the tire, is inclined so that the bottom thereof is located at the inner side than the opening thereof as viewed in the diameter direction of the tire, and is located at the inner side than the first cut groove as viewed in the diameter direction of the tire; wherein the bottom of the first cut groove is located at the inner side than an upper position of the opening of the second cut groove as viewed in the diameter direction of the tire.

In the above pneumatic tire, after the first cut groove is exposed to the tread surface as the tire is used due to the wear, and even when the wear further progresses, a thin groove side end portion of the main land portion shifts toward the inner side along the cut groove as viewed in the width direction of the tire. With such a constitution, the thin groove side end portion of the main land portion can be prevented from being worn in a round shape in cross-section. Also, in the pneumatic tire, the groove bottom of the first cut groove is positioned at inner side than the upper position of the opening of the second cut groove as viewed in the diameter direction of the tire. Therefore, the second cut groove is exposed before the first cut groove is eliminated due to the wear. As a result, from the beginning stage to the final stage of use of the tire, the thin groove side end portion of the main land portion can be always prevented from being worn in a round shape in cross-section. As a result, between the thin groove side end portion of the main land portion and the contact surface of other shoulder land portion, it can be always prevented to generate a difference in diameter of the tire. Therefore, from the beginning stage to the final stage of use of the tire, step-wear in the shoulder land portion can be prevented.

In the pneumatic tire, both depth L1 of the first cut groove and depth L2 of the second cut groove are preferably from 3 to 12 mm. With such a constitution, the durability of a sipe die, which is used for molding cut groove (first cut groove and second cut groove) during vulcanization of the tire can be maintained as well as the stiffness of the main land portion in the shoulder land portion can be appropriately reduced. As a result, the anti-irregular wear performance of the pneumatic tire is further increased.

In the pneumatic tire, both angle θ1 formed by the thin groove and the first cut groove and angle θ2 formed by the thin groove and the second cut groove are preferably from 30° to 65°. With such a constitution, the thickness of a part sandwiched by the thin groove and the cut grooves (first cut groove and second cut groove) can be maintained to prevent generation of chunking.

In the pneumatic tire, both of width W1 of the first cut groove and width W2 of the second cut groove are preferably 1.5 mm or less. With such a constitution, during running of the tire, deformation of a portion between the first cut groove and the second cut groove can be prevented and the thin groove can be prevented from catching stones therein. As a result, durability of the pneumatic tire can be increased while the anti-irregular wear performance of the pneumatic tire is increased.

### BRIEF DESCRIPTION OF THE DRAWINGS

FIG. 1 is a cross-sectional view illustrating an example of a shoulder land portion of a pneumatic tire according to the present invention as viewed in a meridian direction of the tire;

FIG. 2 illustrates a mechanism to prevent step-wear in the pneumatic tire according to the present invention;

FIG. 3 is a cross-sectional view of a shoulder land portion of a pneumatic tire of Comparative Example as viewed in a meridian direction of the tire; and

FIG. 4 is a cross-sectional view of an example illustrating a shoulder land portion of a conventional pneumatic tire as viewed in a meridian direction of the tire.

### DESCRIPTION OF THE PREFERRED EMBODIMENTS

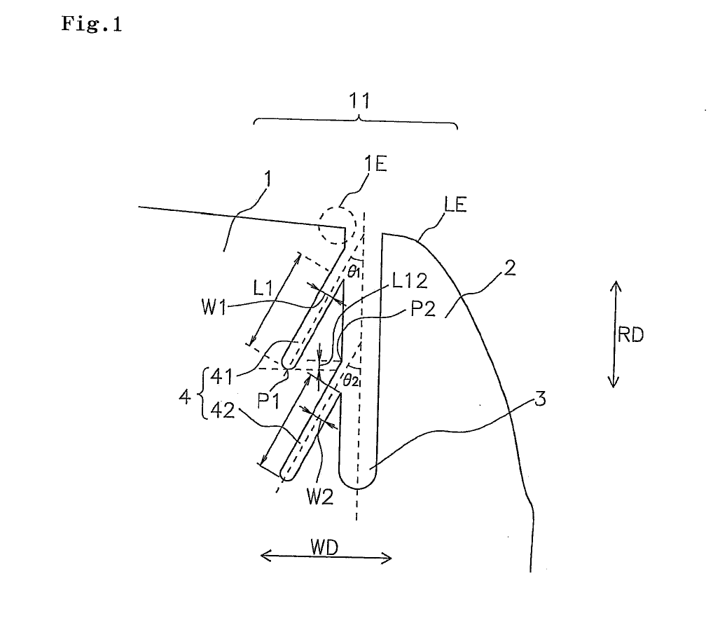

Embodiments of the present invention will be described below. FIG. 1 is a cross-sectional view illustrating an example of a shoulder land portion of a pneumatic tire according to the present invention as viewed in a meridian direction of the tire. In FIG. 1, RD indicates a radial direction and WD indicates a width direction of the tire.

As shown in FIG. 1, the pneumatic tire according to the present embodiment has a tread surface that includes a shoulder land portion 11 extending in a circumferential direction of the tire. The shoulder land portion 11 is formed with a thin groove 3 located at the inner side than a ground-contact end LE in the shoulder land portion 11 as viewed in the width direction of the tire. The thin groove 3 extends in the circumferential direction of the tire and partitions the shoulder land portion 11 into a main land portion 1 located at the inner side thereof and a sacrifice land portion 2 located at the outer side thereof as viewed in the width direction of the tire.

The tread surface is formed with a plurality of main grooves (not shown in FIG. 1) extending in the circumferential direction of the tire as viewed in the width direction of the tire. The shoulder land portion 11 is located at the outer side than a main groove that is located at the outermost side in the main grooves on the tread surface as viewed in the width direction of the tire. The present embodiment shows an example of a tire in which the shoulder land portion 11 including the main land portion 1 and the sacrifice land portion 2 are constituted of a rib type. However, the pneumatic tire according to the present invention can be applicable with no particular limitations to any tread pattern as rib type, block type, lug type or the like.

The thin groove 3 is located at the inner side than the ground-contact end LE of the shoulder land portion 11 as viewed in the width direction of the tire and extends in the circumferential direction of the tire. Here, according to the present invention, in order to effectively reduce irregular wear of the pneumatic tire, the thin groove 3 is preferably formed within, from the ground-contact end LE, a region of 5% in ground-contact width of the tread surface. The depth of thin groove 3 may be appropriately changed depending on the size of the pneumatic tire. For example, in the case of 11R22.5 size, in order to reduce irregular wear of tire, the depth is preferably from 10 to 20 mm, and more preferably from 14 to 16 mm. Also, according to the present embodiment, the thin groove 3 is arranged so that the width is generally uniform from the tread surface to groove bottom as viewed in the width direction WD of the tire. The width of the thin groove 3 is, for example, from 0.5 to 3.0 mm.

The thin groove 3 comprises a first cut groove 41 that extends in a circumferential direction of the tire, has a start point thereof on an inner side wall of the thin groove 3 as viewed in the width direction of the tire, and is inclined so that the bottom thereof is located at the inner side than the opening thereof as viewed in the diameter direction of the tire; and a second cut groove 42 that extends in the circumferential direction of the tire, has a start point thereof on the inner side wall of the thin groove 3 as viewed in the width direction of the tire, is inclined so that the bottom thereof is located at the inner side than the opening thereof as viewed in the diameter direction of the tire, and is located at the inner side than the first cut groove 41 as viewed in the diameter direction of the tire. The second cut groove 42 has a start point thereof on the inner side wall of the thin groove 3 as viewed in the width direction of the tire, and the start point of the second cut groove 42 is located at the inner side (downside in FIG. 1) than the start point of the first cut groove 41 as viewed in the diameter direction of the tire. In the present invention, it is preferable that a cut groove is not set on the outer side wall of the thin groove 3 as viewed in the width direction of the tire so as to prevent the step-wear in shoulder land portion 11.

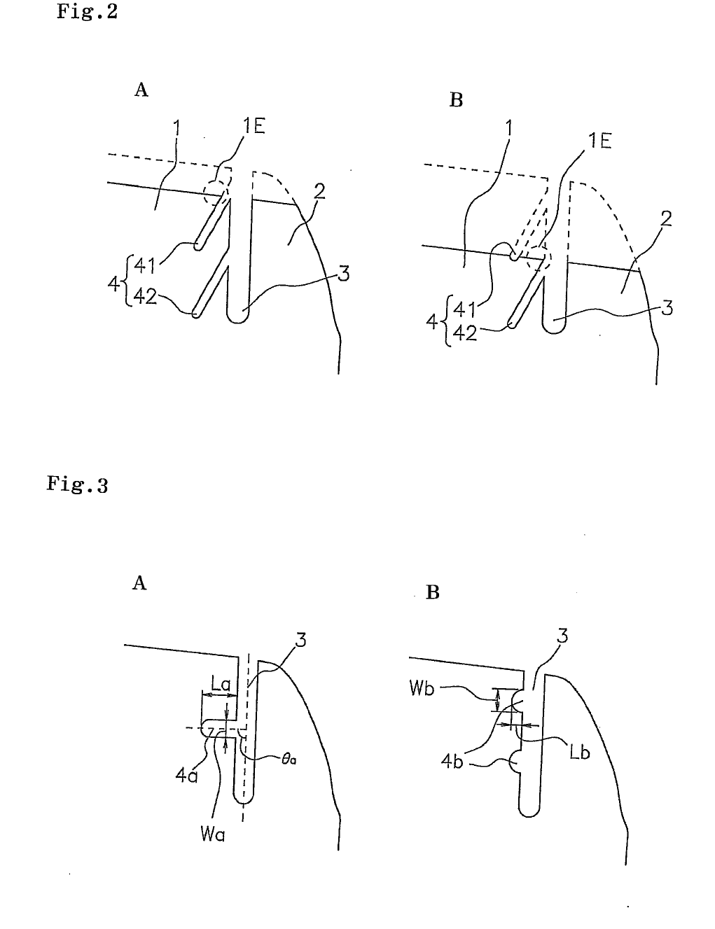

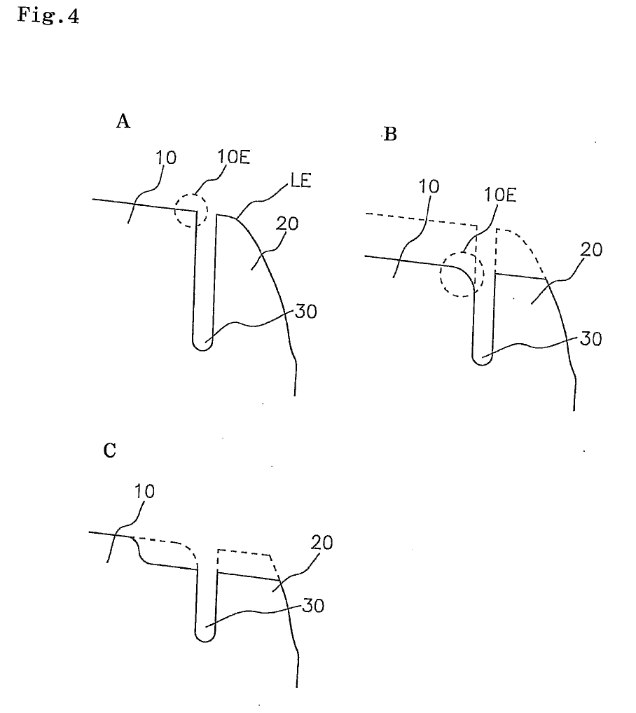

As shown in FIG. 1, bottom position P1 of the first cut groove 41 is located at the inner side than an upper position P2 of the opening of the second cut groove as viewed in the diameter direction of the tire. With such a constitution, in the pneumatic tire according to the present invention, from the beginning stage to the final stage of use of the tire, step-wear in the shoulder land portion can be prevented. Mechanism in the present invention to prevent the step-wear of the shoulder land portion will be described below with reference to FIG. 2.

In a virgin stage of the tire, the first cut groove 41 (and the second cut groove 42) is not exposed to the tread contact surface (a state shown in FIG. 1). As the tire is used, the first cut groove 41 is exposed to the tread contact surface due to the wear (a state shown in FIG. 2A). Even when the wear further progresses after the first cut groove 41 is exposed, a thin groove side end portion 1E of the main land portion 1 shifts toward the inside of the tire along the first cut groove 41 as viewed in the width direction of the tire. This constitution prevents such a problem that the thin groove side end portion 1E of the main land portion 1 is worn in a round shape in cross-section.

Even when the wear further progresses to eliminate the first cut groove 41 as the tire is used, the second cut groove 42 is exposed before the first cut groove 41 is eliminated due to the wear (a state shown in FIG. 2B). Even when the wear progresses after the second cut groove 42 is exposed, the thin groove side end portion 1E of the main land portion 1 shifts toward the inside of the tire along the second cut groove 42 as viewed in the width direction of the tire. As a result, the problem that the thin groove side end portion 1E of the main land portion 1 is worn in a round shape in cross-section is prevented any time from the beginning stage to the final stage of use of the tire. This constitution always prevents such a problem that diameter of the tire in the thin groove side end portion 1E of the main land portion 1 is different from that in the contact surface of the other shoulder land portion. Thus, the step-wear in the shoulder land portion can be prevented from the beginning stage to the final stage of use of the tire.

In the present invention, to prevent the step-wear in the shoulder land portion 11 more effectively, the distance L12 from a bottom position P1 of the first cut groove 41 to the upper position P2 of the opening of the second cut groove in a normal line direction of the tread contact surface is preferably from 0.5 to 1.5 mm.

In the present invention, both of the depth L1 of the first cut groove 41 and the depth L2 of the second cut groove 42 are preferably from 3 to 12 mm. This constitution ensures the durability of sipe-die, which is used for forming cut groove when vulcanizing the tire while appropriately reducing the stiffness of the main land portion 1 in the shoulder land portion 11. As a result, anti-irregular wear performance of the pneumatic tire can be further increased. To further increase the anti-irregular wear performance of the pneumatic tire, both of the depth L1 of the first cut groove 41 and the depth L2 of the second cut groove 42 are preferably set to be 5 to 8 mm. The depths of L1 and L2 may be the same or different from each other.

Also, in the present invention, both of the angle θ1, which is formed by the thin groove 3 and the first cut groove 41, and the angle θ2, which is formed by the thin groove 3 and the second cut groove 42, are preferably set to 30° to 65°; more preferably 30° to 40°. This constitution ensures the thickness of a portion sandwiched by the thin groove 3 and the first cut groove 41 and a portion sandwiched by the thin groove 3 and the second cut groove 42; and thus prevents chunking. The θ1 indicates an angle formed by the center line of the width of thin groove 3 and the center line of the width of the first cut groove 41; the θ2 indicates an angle formed by the center line of the width of the thin groove 3 and the center line of the width of the second cut groove 42. These θ1 and θ2 may be the same or different from each other.

Furthermore, both of the width W1 of the first cut groove 41 and the width W2 of the second cut groove 42 shown in FIG. 1 are preferably 1.5 mm or less. This constitution prevents deformation in a portion between the first cut groove 41 and the second cut groove 42 during use of the tire; and thus prevents catching stones in the thin groove 3. As a result, not only anti-irregular wear performance of the pneumatic tire but also durability thereof can be increased. Here, W1 and W2 may be the same or different from each other. In order to reliably prevent the step-wear in the shoulder land portion 11, the lower limit of the width W1 of the first cut groove 41 and the width W2 of the second cut groove 42 is preferably 0.5 mm or more.

As described above, the present invention provides step-wear prevention effect. Therefore, the present invention is effectively applicable particularly to a heavy load pneumatic tire that has a shoulder rib having a considerable problem of step-wear in the thin groove side end portion of the main land portion of the shoulder land portion.

The pneumatic tire of the present invention is identical to ordinarily pneumatic tires excepting a point that the thin groove and the cut groove are arranged as described above. Therefore, conventionally well-known materials, shape, structure, manufacturing methods are applicable to the present invention.

### Other Embodiment

The above described embodiment gives an example in which the thin groove 3 includes the first cut groove 41, which has its start point on the inner side wall thereof as viewed in the width direction of the tire and extends inward as viewed in the diameter direction of the tire, and the second cut groove 42, which has its start point on the inner side wall thereof as viewed in the width direction of the tire and extends inward as viewed in the diameter direction of the tire (an example in which the thin groove includes two cut grooves). However, in the present invention, the thin groove may further have a third cut groove at the inner side than the second cut groove as viewed in the diameter direction of the tire. In this case also, groove bottom position of the second cut groove is located at the inner side than an upper position of the opening of the third cut groove as viewed in the diameter direction of the tire; thereby from the beginning stage to the final stage of use of the tire, step-wear in the shoulder land portion can be prevented.

### EXAMPLES

Example and Comparative Examples that particularly demonstrate the structure and effects of the present invention will be described below. Evaluation was made on the respective Example and Comparative Examples as described below.

### Anti-Irregular Wear Performance

Test tires (295/75R22.5) were mounted on the front wheels of a tractor head of a long distance transportation track and after running 80,000 km on a dry road, width of step-worn portion was measured in the width direction of the tire. Inverse numbers of the measured values were subjected to evaluation indexes. Defining the value of Comparative Example 1 as 100, the evaluation was made with indexes. The larger the numerical value, anti-irregular wear performance becomes more satisfactory.

### Example 1

Pneumatic tire having the shoulder land portion 11 arranged as shown in FIG. 1 (the depth of the thin groove 3: 15 mm, the width of the thin groove 3: 2.5 mm, L1=6.5 mm, L2=6.5 mm, L12=1 mm, θ1=30°, θ2=30°, W1=1 mm, W2=1 mm) was prepared. Using such a pneumatic tire, the above evaluation was conducted. Test results are shown in Table 1.

### Comparative Example 1

### Conventional Example)

A pneumatic tire having the same constitution as in Example 1, with the exception that only the thin groove 3 is formed (cut groove 4 is not formed) in the constitution shown in FIG. 1, was prepared. Using such a pneumatic tire, the above evaluation was conducted. Test results are shown in Table 1.

### Comparative Example 2

A pneumatic tire having the same constitution as in Example 1, with the exception that θa=90°, La=4 mm, Wa=2 mm in the constitution shown in FIG. 3A (a lateral groove 4a which has its start point on the inner side wall of the thin groove 3 as viewed in the width direction of the tire), was prepared. Using such pneumatic tires, the above-described evaluation was conducted. Test result is shown in Table 1.

### Comparative Example 3

A pneumatic tire having the same constitution as in Example 1, with the exception that Lb=1.25 mm and Wb=2.5 mm in the constitution shown in FIG. 3B (two lateral grooves 4b which have its start point on the inner side wall of the thin groove 3 as viewed in the width direction of the tire), was prepared. Using such a pneumatic tire, the above-described evaluation was conducted. Test results are shown in Table 1.

TABLE 1

| | Comparative | | Comparative | Comparative |
|---|---|---|---|---|
| | Example 1 | Example 1 | Example 2 | Example 3 |
| Anti-irregular | 100 | 161 | 104 | 109 |
| wear | | | | |
| performance | | | | |

As shown in Table 1, it is demonstrated that the pneumatic tire of Example 1, compared to the pneumatic tire of Comparative Example 1, anti-irregular wear performance is drastically improved. On the other hand, it is found that, in the pneumatic tire of Comparative Example 2 and Comparative Example 3, compared to the pneumatic tire of Comparative Example 1, although the anti-irregular wear performance is slightly improved. However, compared to the pneumatic tire of Example 1, the anti-irregular wear performance is reduced.

What is claimed is:

1. A pneumatic tire comprising a tread surface,
the tread surface including:
a shoulder land portion extending in a circumferential direction of the tire; and
a thin groove located at the inner side than a ground-contact end of the shoulder land portion as viewed in a width direction of the tire and extending in a circumferential direction of the tire, the thin groove partitioning the shoulder land portion into a main land portion located at the inner side and a sacrifice land portion located at the outer side of the shoulder land portion as viewed in the width direction of the tire;
the thin groove comprising:
a first cut groove that extends in a circumferential direction of the tire, has a start point thereof on an inner side wall of the thin groove as viewed in the width direction of the tire, and is inclined so that the bottom thereof is located at the inner side than the opening thereof as viewed in the diameter direction of the tire; and
a second cut groove that extends in the circumferential direction of the tire, has a start point thereof on the inner side wall of the thin groove as viewed in the width direction of the tire, is inclined so that the bottom thereof is located at the inner side than the opening thereof as viewed in the diameter direction of the tire, and is located at the inner side than the first cut groove as viewed in the diameter direction of the tire; wherein
the bottom of the first cut groove is located at the inner side than an upper position of the opening of the second cut groove as viewed in the diameter direction of the tire.

2. The pneumatic tire according to claim 1, wherein both depth L1 of the first cut groove and depth L2 of the second cut groove are from 3 to 12 mm.

3. The pneumatic tire according to claim 1, wherein both angle θ1 formed by the thin groove and the first cut groove and angle θ2 formed by the thin groove and the second cut groove are from 30° to 65°.

4. The pneumatic tire according to claim 1, wherein both width W1 of the first cut groove and width W2 of the second cut groove are 1.5 mm or less.
